(19) United States
(12) Patent Application Publication
(10) Pub. No.: US 2023/0133800 A1
(43) Pub. Date: May 4, 2023

(54) CONFIGURING A MACHINE LEARNING MODEL BASED ON DATA RECEIVED FROM A PLURALITY OF DATA SOURCES

(71) Applicant: Capital One Services, LLC, McLean, VA (US)

(72) Inventors: Vincent Pham, Champaign, IL (US); Nahid Farhady Ghalaty, Fairfax, VA (US); Christopher Camenares, Falls Church, VA (US); Lee Adcock, Midlothian, VA (US)

(21) Appl. No.: 17/514,489

(22) Filed: Oct. 29, 2021

(51) Int. Cl. G06N 20/00

(52) U.S. Cl. CPC G06N 20/00

(57) ABSTRACT

Aspects described herein relate to aggregating data records received from a plurality of data sources and selecting, for each of the plurality of data sources, a subset of data from the resulting aggregated data records. The aggregation and selecting processes may be performed in a randomized fashion. Further, the subsets of data may have portions that overlap with each other. Each subset may be used to train a model. Configuration information from any model trained in this way may then be used to configure an aggregated model. The overlap may also be used as basis for configuring the aggregated model. Once the aggregated model is configured, the aggregated model may be used to determine predictions.

### FIELD

Aspects described herein relate generally to machine learning models, training of machine learning models, and configuring of machine learning models. Further aspects described herein may relate to implementing machine learning models based on training data, or other data, that is received from a plurality of data sources.

### BACKGROUND

Implementing a machine learning model so that it is suitable for its intended purpose may be a time consuming and difficult process. The time consuming and difficult nature of implementing a machine learning model may be illustrated by the challenges in training, or otherwise configuring, a machine learning model as the model itself grows in size. For example, training a machine learning model, of a particular size, may use a volume of training data that is insufficient for training larger machine learning models. Indeed, as machine learning models grow increasingly large, the volume of training data sufficient for training these increasingly large machine learning models may grow exponentially. This increases the difficulty both in gathering an appropriately-sized training set for training a machine learning model and in meeting the demand for computation power required for performing the training.

Moreover, the time consuming and challenging nature of implementing a machine learning model may be illustrated by the challenges in processing training data, or other data, received from a plurality of data sources. For example, each data source may have its own procedure in how its training data is to be handled and these procedures may be of variable complexity. Further, these procedures may require enforcement of data privacy, data security, and/or data confidentiality. In this way, ensuring these procedures are followed bring numerous challenges in training, or otherwise configuring, a machine learning model based on the training data received from a plurality of data sources. The above examples are only a few of the challenges that may illustrate the time consuming and difficult process of implementing a machine learning model.

### SUMMARY

The following paragraphs present a simplified summary of various aspects described herein. This summary is not an extensive overview, and is not intended to identify key or critical elements or to delineate the scope of any claim. This summary merely presents some concepts in a simplified form as an introductory prelude to the more detailed description provided below.

Aspects described herein may address the above-mentioned challenges and difficulties, and generally improve training, and configuring of, one or more machine learning models. Further, aspects described herein may address one or more challenges and difficulties in implementing machine learning models based on training data, or other data, received from a plurality of data sources.

Aspects described herein relate to aggregating data records received from a plurality of data sources and selecting, for each of the plurality of data sources, a subset of data from the resulting aggregated data records. The aggregation and selecting processes may be performed in a randomized fashion. Further, the subsets of data may have portions that overlap with each other. Each subset may be used to train a model. Configuration information from any model trained in this way may then be used to configure an aggregated model. The overlap may also be used as basis for configuring the aggregated model. Once the aggregated model is configured, the aggregated model may be used to determine predictions.

The manner in which the data is aggregated and otherwise processed may address one or more challenges and difficulties in implementing machine learning models. For example, the various ways in which data is aggregated may improve data privacy and/or data security. The data, as it is aggregated, may be ordered in a randomized fashion and, due to the randomized fashion, it may be more difficult to determine which source sent particular portions of the resulting aggregated data. As another example, confidential data may be hashed or encrypted such that the confidential data is not directly disclosed to other data sources. The manner in which the selections from the aggregated data are performed may address one or more further challenges and difficulties in implementing machine learning models. For example, the various ways in which subsets of data are selected and then used for training a plurality of models may improve the manner in which larger machine learning models can be configured.

These features, along with many others, are discussed in greater detail below. Corresponding apparatus, systems, and computer-readable media are also within the scope of the disclosure.

### BRIEF DESCRIPTION OF THE DRAWINGS

The present disclosure is illustrated by way of example and not limited in the accompanying figures in which like reference numerals indicate similar elements and in which:

FIG. 1 depicts a block diagram of an example computing environment that may implement one or more machine learning models based on data received from a plurality of data sources in accordance with various aspects described herein.

FIG. 2 depicts examples of data that may be used and/or generated in connection with various aspects described herein.

FIGS. 3A-3F depict an example process flow where one or more machine learning models are trained, configured, and otherwise used based on data received from a plurality of data sources in accordance with various aspects described herein.

FIG. 4 depicts an example method for configuring a machine learning model based on data received from a plurality of data sources in accordance with various aspects described herein.

FIG. 5 depicts an example of a computing device that may be used in implementing one or more aspects described herein.

### DETAILED DESCRIPTION

In the following description of the various embodiments, reference is made to the accompanying drawings, which form a part hereof, and in which is shown by way of illustration various embodiments in which aspects of the disclosure may be practiced. It is to be understood that other embodiments may be utilized and structural and functional modifications may be made without departing from the scope of the present disclosure. Aspects of the disclosure are capable of other embodiments and of being practiced or being carried out in various ways. Also, it is to be understood that the phraseology and terminology used herein are for the purpose of description and should not be regarded as limiting. Rather, the phrases and terms used herein are to be given their broadest interpretation and meaning. The use of “including” and “comprising” and variations thereof is meant to encompass the items listed thereafter and equivalents thereof as well as additional items and equivalents thereof.

Throughout this disclosure, the phrases “confidential information” and “confidential data” are used and may refer to any information or data that is subject to confidentiality procedures that restrict access and/or restrict disclosure of the confidential information or confidential data. Examples of confidential information or confidential data may include account numbers, social security numbers, and the like. As an example of a confidentiality procedure, the confidential information or confidential data may be prevented from being disclosed to any user, device, or entity that does not have appropriate access rights. A confidentiality procedure may be defined by one or more data policies. For example, a data source may make data records available for training machine learning models or as part of some other data sharing agreement. The data source may make its data records available subject to a particular data policy, and this data policy may indicate, for example, that access to account numbers or other customer information is to be restricted in some manner A confidentiality procedure may be based on one or more legal or regulatory requirements. For example, social security numbers may be subject to one or more confidentiality procedures based on one or more United States Federal laws or regulations.

By way of introduction, aspects discussed herein may relate to methods and techniques for training, or otherwise configuring, one or more machine learning models based on data received from a plurality of data sources. The one or more machine learning models may include a machine learning model for each data source. In other words, each data source may have its own machine learning model trained according to the methods and techniques described herein. The one or more machine learning models may also include a machine learning model trained, or configured, based on an aggregation of the data received from the plurality of data sources. In this way, the data received from the plurality of data sources may be collected together and used to train, or otherwise, configure a machine learning model. The methods and techniques described herein, and/or various combinations of the features described herein, may improve training, and configuring of, one or more machine learning models. Further, methods and techniques described herein, and/or various combinations of the features described herein may improve the ability to implement machine learning models based on training data, or other data, received from a plurality of data sources.

A machine learning model may be referred interchangeably herein as a model. Throughout this disclosure, the different instances of “training a model” and “configuring a model” is intentional and indicates different processes. For example, training a model may include performing a training algorithm using a particular set of training data. Configuring a model may include determining a configuration of the model based on the configuration of one or more other models and then configuring the model according to the determined configuration. In other words, configuring a model may not involve performing a training algorithm for that model. Instead, training algorithms may be performed for other models. After the training algorithms are complete, the other models can be used as a basis for determining the configuration of the model. For simplicity, throughout this disclosure, a model that is configured (and not trained) will be referred to as an aggregated model. A model that is trained (and not configured) will be referred to as a first model, second model, third model, fourth model, and the like. The details of these methods and techniques, among other aspects, will be described in more detail herein.

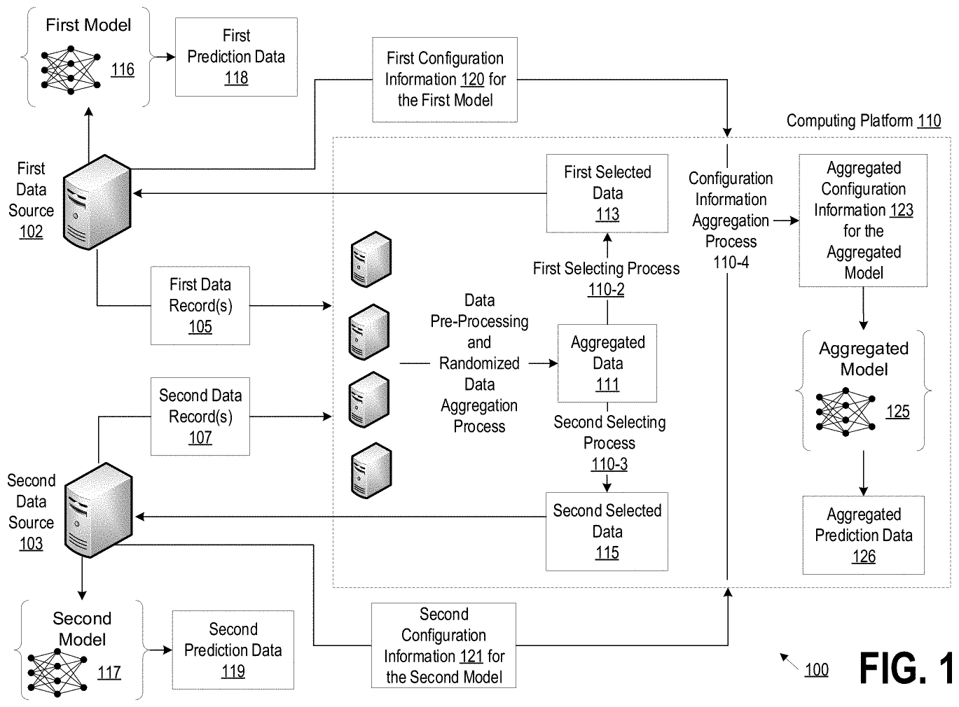

FIG. 1 depicts a block diagram of an example computing environment 100 that may implement one or more machine learning models based on data received from a plurality of data sources. As a brief overview, the example computing environment 100 includes a computing platform 110 that may receive data from a plurality of data sources. The computing platform 110 may be configured to send selected portions of the received data back to the plurality of data sources (e.g., first selected data 113 and second selected data 115). These selected portions may be used to train one or more machine learning models (e.g., the first model 116 and the second model 117). Once trained, the one or more machine learning models, or more specifically the trained configurations of the one or more machine learning models (e.g., the one or more first model weights 119 and the one or more second model weights 121), can be used a basis for configuring another machine learning model (e.g., the aggregated model 125).

For simplicity, the example computing environment 100 depicts the computing platform 110 as receiving data from two data sources. The computing platform 110 receives one or more first data records 105 from a first data source 102 and receives one or more second data records 107 from a second data source 103. The two data sources 102, 103 are shown as one example. As will become apparent based on other examples discussed throughout this disclosure, the exact number of data sources is not limited to two data sources. Moreover, the computing platform 110 may be a data source itself. In this way, the computing platform 110 may be a third data source and may provide its own one or more third data records (not shown) that can be aggregated with the one or more first data records 105 and the one or more second data records 107. In such instances, the computing platform 110 may have its own model (e.g., a third model, not shown) in addition to the aggregated model 125 and may perform processes similar to those discussed in connection with the two data sources 102, 103. Additionally, each of the two data sources 102, 103 is depicted as being a single device. An example of a suitable single device may be a server, a personal computer, a mobile device, an automated teller machine, or the like. The server, personal computer, or mobile device, for example, may be associated with a customer or client of a service provided via the computing platform 110 (e.g., a banking service where the computing platform 110 is operated by a bank). The server, personal computer, or mobile device may be generating data records associated with the customer or client and forwarding them to the computing platform 110 for processing. In addition to the two data sources 102, 103 being implemented as a single device, the two data sources 102, 103 may each be implemented on one or more computing devices, one or more computing systems, one or more computing platforms, and/or other arrangement of devices that are configured to perform processes similar to those discussed in connection with the two data sources 102, 103. Computing devices, computing systems, and/or computing platforms of a data source may be interconnected to each other via one or more networks (not shown). The computing platform 110 is depicted as being four devices, but may be implemented as one or more computing devices.

As also depicted, each of the two data sources 102, 103 and the computing platform 110 is depicted as having its own model. The first data source 102 has a first model 116, the second data source 103 has a second model 117, and the computing platform 110 has an aggregated model 125. Each model discussed throughout this disclosure, including those depicted in FIG. 1, may be any suitable machine learning model that is configured, or usable, to generate prediction data. For example, each model may be a convolutional network architecture, a recurrent neural network architecture, a deep neural network, a Variational autoencoder (VAE), a transformer, or a combination of the aforementioned model types. Examples of a suitable recurrent neural network architecture include a long short-term memory (LSTM) and a Gated Recurrent Unit (GRU).

The first model 116, the second model 117, and/or the aggregated model 125 may be the same or similar to each other in size. As one example, each of the first model 116, the second model 117, and the aggregated model 125 may include a neural network, and each neural network may have the same number of inputs, layers, and outputs. The first model 116, the second model 117, and/or the aggregated model 125 may be of different sizes. As one example, each of the first model 116, the second model 117, and the aggregated model 125 may include a neural network, and each neural network may include a different number of inputs, layers, and outputs from the other neural networks. As another example, the first model 116 and the second model 117 may include neural networks that have the same number of inputs, layers, and outputs as each other, but aggregated model 125 may include a larger neural network (e.g., have more inputs, layers, and/or outputs than the neural networks of the first model 116 and the second model 117).

As depicted in FIG. 1, each model is shown as outputting its own prediction data. The first model 116 is shown as outputting first prediction data 118. The second model 117 is shown as outputting second prediction data 119. The aggregated model 125 is shown as outputting aggregated prediction data 126. To provide illustrative examples of the aspects described herein, each model will be discussed as being implemented to predict user behavior. Accordingly, the first prediction data 118 may include, or otherwise indicate, one or more first predictions of user behavior. The second prediction data 119 may include, or otherwise indicate, one or more second predictions of user behavior. The aggregated prediction data 126 may include, or otherwise indicate, one or more aggregated predictions of user behavior. In this way, the one or more first data records 105 and the one or more second data records 107 will be discussed in terms of including data suitable for training a model to predict user behavior. If the models were changed to predict something other than user behavior, the types of data included in the data records 105, 107 may also change. In this way, the examples of the prediction data and the data records discussed throughout this disclosure is only an example of the types of prediction data and data records that could be used to implement one or more machine learning models based on data received from a plurality of data sources. Additionally, each model is depicted as outputting prediction data itself for simplicity. A model may not be configured to generate prediction data themselves. Each model may be configured to generate output data indicative of prediction data. That output data may need to be processed to translate or convert that output data to a more suitable form (e.g., translate or convert the output data generated by each model to a text string that indicates a prediction).

The computing platform 110 and the devices of the two data sources 102, 103 are depicted in FIG. 1 as being used to perform various processes in connection with training the first model 116, training the second model 117, and configuring the aggregated model 125. As a general overview of these processes, the first data source 102 may send the one or more first data records 105 to the computing platform 110. The second data source 103 may send the one or more second data records 107 to the computing platform 110. Based on their receipt, the computing platform 110 may perform data pre-processing and a randomized data aggregation process 110-1 on the one or more first data records 105 and the one or more second data records 107. The data pre-processing and the randomized data aggregation process 110-1 may, in part, determine aggregated data 111. The aggregated data 111 may include versions of both the one or more first data records 105 and the one or more second data records 107. Based on the aggregated data 111, the computing platform 110 may perform a first selecting process 110-2 that, at least in part, determines first selected data 113. Also based on the aggregated data 111, the computing platform 110 may perform a second selecting process 110-3 that, at least in part, determines second selected data 115. Each of the first selecting process 110-2 and the second selecting process 110-3 may select a subset of data from the aggregated data 111 that will be used to train a model at one of the two data sources 102, 103. Accordingly, the first selected data 113 may include a first subset of data from the aggregated data 111 and the second selected data 113 may include a second subset of data from the aggregated data 111. The computing platform 110 may send the first selected data 113 to the first data source 102 and may send the second selected data 115 to the second data source 103.

After receiving the first selected data 113 from the computing platform 110, the first data source 102 may train the first model 116 based on the first selected data 113. Similarly, after receiving the second selected data 115 from the computing platform 110, the second data source 103 may train the second model 117 based on the second selected data 115. After training, each of the first model 116 and the second model 117 may be usable to determine, respectively, first prediction data 118 and second prediction data 119. Additionally, after training, both data sources 102, 103 may be able to extract, or otherwise determine, configuration information of the trained models 116, 117. The configuration information may include weights, biases, and/or any other learned or configurable parameter of the trained models 116, 117. The types of parameters that can be included by the configuration information may depend on the type of model being used (e.g., a neural network-based model may have configuration that includes weights and/or biases). The configuration information may be sent to the computing platform 110 to be used as a basis for configuring the aggregated model 125. In this way, FIG. 1 depicts the first data source 102 sending first configuration information 120 to the computing platform 110 and the second data source 103 sending second configuration information 121 to the computing platform 110. For simplicity, many of the examples discussed throughout this disclosure will discuss the configuration information of models as being, or otherwise including, weights and/or bias. In this way, the first configuration information 120 may include one or more first model weights of the first model 116 and one or more first biases of the first model 116. The second configuration information 121 may include one or more second model weights of the second model 117 and one or more second biases of the second model 117. A model weight may indicate a parameter of a model that transforms data within the model. A model weight may, for example, indicate a strength of connection between two nodes of a neural network, and as data passes between the two nodes the data may be multiplied, or otherwise transformed by, the model weight. A bias, which may sometimes be referred to as an offset, may indicate a parameter of a model that is a constant-value input to a neuron or layer within the model.

Based on the first configuration information 120 and the second configuration information 121, the computing platform may perform a configuration information aggregation process 110-4 that, in part, determines aggregated configuration information 123 for the aggregated model 125. The aggregated configuration information 123 may include one or more aggregated weights for the aggregated model 125 and/or one or more aggregated biases for the aggregated model 125. The one or more aggregated model weights may, for example, combine the one or more first model weights with the one or more second model weights (e.g., by summing, normalizing, and/or some other process). The one or more aggregated biases may combine the one or more first biases with the one or more second biases (e.g., by summing, by normalizing, by using an or operator, by using an exclusive or operator, and/or by some other process). The computing platform 110 may then configure the aggregated model 125 using the aggregated configuration information 123. After the aggregated model 125 is configured, the aggregated model 125 may be usable to determine aggregated prediction data 126. Additionally, after the aggregated model 125 is configured, the aggregated model 125 and/or the aggregated configuration information 123 may be sent (not shown) to one or more of the data sources 102, 103. In this way, the data sources 102, 103 may be able to make predictions using the aggregated model 125 and/or another model configured using the aggregated configuration information 123.

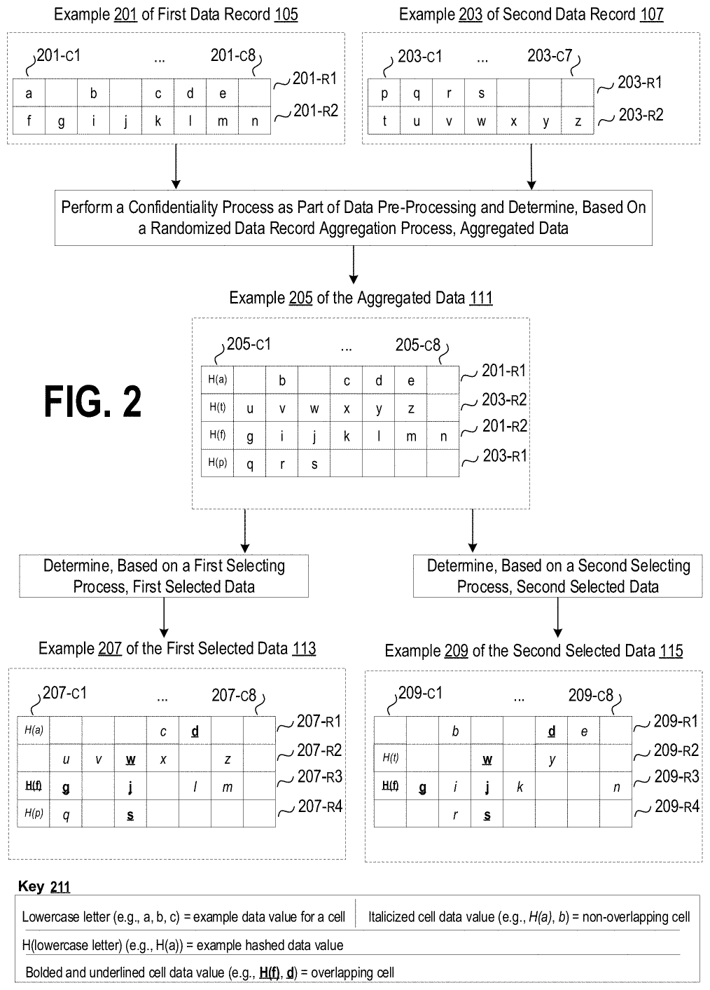

FIG. 2 depicts examples of data that may be used and/or generated in connection with training the first model 116, training the second model 117, and configuring the aggregated model 125. The examples of FIG. 2 will be used as a basis for providing additional details on the various processes performed by the devices of the example computing environment 100 of FIG. 1. FIG. 2 provides a key 211 to assist in describing the examples depicted in FIG. 2.

To begin the examples that combine the example computing environment 100 of FIG. 1 and the examples of FIG. 2, the two data sources 102, 103 may be for different customers, clients, businesses or enterprises, or for different divisions within a single business or enterprise. Each of the two data sources 102, 103 may be conducting various transactions with its one or more users and each of the two data sources 102, 103 may, as a result of those transactions, be collecting or otherwise generating data records indicative of the transactions. Accordingly, the first data source 102 may be collecting or otherwise generating one or more first data records 105 that are indicative of transactions with the first data source 102. The second data source 103 may be collecting or otherwise generating one or more second data records 105 that are indicative of transactions with the second data source 103. As some examples, a data record may include data from or indicative of an email, user record data, call log data, account information, chat log data, transaction data, and the like. As a particular example, the first data source 102 may be for a first bank and the second data source 103 may be for a second bank. Under this example, the one or more first data records 105 may include data indicative of banking transactions with the first bank and/or account information for account holders of the first bank. The one or more second data records 107 may include data indicative of banking transactions with the second bank and/or account information for account holders of the second bank. As another particular example, the first data source 102 may be for a first credit card type issued by a bank and the second data source 103 may be for a second credit card type issued by the bank. Under this example, the one or more first data records 105 may include data indicative of credit card transactions using the first credit card type and/or account information for users issued the first credit card type. The one or more second data records 107 may include data indicative of credit card transactions using the second credit card type and/or account information for users issued the second credit card type.

FIG. 2 depicts examples of data records. In particular, FIG. 2 provides an example 201 of a first data record 105 and a second example 203 of a second data record 107. The example 201 may be interchangeably referred to as an example first data record 201. The example 203 may be interchangeably referred to as an example second data record 203. As depicted, each example data record 201, 203 is formatted into rows and columns of cells. The example first data record 201 includes 2 rows (201-r1 to 201-r2) and 8 columns of cells (201-c1 to 201-c8). The example second data record 203 includes 2 rows (203-r1 to 203-r2) and 7 columns (203-c1 to 201-c7) of cells. The number of rows and/or columns in each data record may differ from each other. In this way, FIG. 2 shows the example data records 201, 203 having different number of columns (7 columns versus 8 columns). A cell may include various types of data including, for example, numeric data, textual data, image data, and the like. A cell may also be blank or not include any data. Some of the cells may include confidential information. For example, the first column 201-c1, 203-c1 of each example data record 201, 203 may include an account number a user or social security number of the user, and such data may be subject to one or more confidentiality procedures. Each row 201-r1, 201-r2, 203-r1, 203-r2 of the example data records 201, 203 may include data indicative of a particular transaction. For example, the first row 201-r1 of the example first data record 201 may be indicative of a first transaction using a credit card and the second row 201-r2 of the example first data record 201 may be indicative of a first transaction with a savings account. For simplicity, FIG. 2 depicts example data values for the cells of the example data records 201, 203 by way of lowercase letters (e.g., a, b, c, d). A cell of the example data records 201, 203 without a lowercase letter may be considered to be blank or to not include any data. For simplicity, a cell that is blank or does not include data may be interchangeably referred to as a “blank cell” or an “empty cell”.

Once collected, or otherwise generated, the one or more first data records 105 and the one or more second data records 107 may be sent from their respective data source 102, 103 to the computing platform 110. After receipt, the computing platform 110 may perform data pre-processing and a randomized data aggregation process 110-1 on the one or more first data records 105 and the one or more second data records 107. The data pre-processing and the randomized data aggregation process 110-1 may, in part, determine aggregated data 111.

FIG. 2 depicts an example 205 of the aggregated data 111 and, consequently, provides examples of data pre-processing and randomized data record aggregation process 110-1 that are performed by the computing platform 110. The example 205 of the aggregated data 111 may be interchangeably referred to as example aggregated data 205. As depicted, the example aggregated data 205 is formatted into rows and columns.

As depicted, the formatting of the example aggregated data 205 provides one or more examples of the data pre-processing. For example, if the example aggregated data 205 is compared to the example second data record 203, the number of columns for rows 203-r1 and 203-r2 has changed such that each row of the example aggregated data 205 has the same number of columns. In this way, data pre-processing may include one or more reformatting processes so that each row included in the example aggregated data 205 has the same number of columns.

Reformatting so that each row of the example aggregated data 205 has the same number of columns can be performed in various ways. For example, the reformatting may be performed based on a maximum number of columns, based on the columns of the data records aligning with each other, or based on the columns of the data records not aligning with each other. The reformatting may be performed by way of appending one or more columns to a data record and/or by way of reordering the columns of a data record. Any information needed to determine the maximum number of columns in the example data records 201, 203, and/or whether the columns of the example data records 201, 203 will or will not align may be received from the two data sources 102, 103 and/or input by a user of the computing platform 110.

As depicted, the example aggregated data 205 includes eight columns 205-c1 to 205-c8. The example aggregated data 205 may have eight columns based on that being the maximum number of columns between the example first data record 201 and the example second data record 203. Indeed, the example first data record 201 includes eight columns and the example second data record 203 includes seven columns. Accordingly, to compensate for the differences in the number of columns between the two data records 201, 203, the one or more reformatting processes may append an eighth column to the rows 203-r1, 203-r2 of the example second data record 203. In this way, the one or more reformatting processes may be performed based on a maximum number of columns.

Further, the example aggregated data 205 may have eight columns based on the columns of the example first data record 201 and the example second data record 203 aligning if the rows 203-r1, 203-r2 of the example second data record 203 are appended with an additional column having blank cells. Such alignment may occur if, for example, the data records indicate the same or similar types of transactions. As one particular example, the example first data record 201 may be indicative of banking transactions with a first bank and the example second data record 203 may be indicative of banking transactions with a second bank. The columns 201-c1 to 201-c7 of the example first data record 201 and the columns 203-c1 to 201-c7 of the example second data record 203 may be for the same types of data (e.g., account number, total amount deposited, withdrawal amount, deposit amount, etc.) and may be in the same order. The first bank may track additional information that is not tracked by the second bank and, thus, may include the eighth column 201-c8 of the example first data record 201 for that additional information. Accordingly, to compensate for this additional information being tracked by the first bank, the one or more reformatting processes may append an eighth column of blank cells to the rows 203-r1, 203-r2 of the example second data record 203. In this way, the one or more reformatting processes may be performed based on the columns of the data records aligning with each other.

In some instances, the columns of the data records may align with each other by re-ordering one or more columns (not shown). In such instances, the one or more reformatting processes may re-order the one or more columns so that the columns of the data records align. Such alignment may occur if, for example, the data records indicate the same or similar types of transactions. As one particular example, the example first data record 201 may be indicative of banking transactions with a first bank and the example second data record 203 may be indicative of banking transactions with a second bank. The columns 201-c1 to 201-c7 of the example first data record 201 and the columns 203-c1 to 201-c7 of the example second data record 203 may be for the same types of data (e.g., account number, total amount deposited, withdrawal amount, deposit amount, etc.), but may be in a different order. For example, the fourth column 201-c4 of the example first data record 201 may be for the withdrawal amount, but the fifth column 203-c5 of the example second data record 201 may be for the withdrawal amount. Accordingly, to compensate for this difference in column order for the withdrawal amount, the one or more reformatting processes may modify the column order such that the withdrawal amount is within the same column across all rows 201-r1, 201-r2, 201-r3, 201-r4. In this way, the one or more reformatting processes may be performed based on the columns of the data records aligning with each other.

In some instances, the columns of the data records may not align with each other by appending one or more columns to the data record having fewer columns (not shown). In such instances, the one or more reformatting processes may append one or more columns to each data record. For example, if the sixth and seventh columns 201-c6, 201-c7 of the example first data record 201 are for different types of data than the sixth and seventh columns 203-c6, 201-c7 of the example second data record 203, the one or more reformatting processes may append two columns to each row 201-r1, 201-r2, 203-r1, 203-r2 of the example first data record 201 and the example second data record 203, and may modify the rows of one of the two example data records 201, 203 such that data values of the sixth and seventh columns are moved to the two appended columns. This may result in aggregated data (not shown) that includes ten columns. The data records may not align with each other if, for example, the data records indicate different types of transactions. For example, the example first data record 201 may be indicative of banking transactions with a first bank and the example second data record 203 may be indicative of credit card transactions. One or more columns of the example data records 201, 203 may be for different types of data. For example, the fourth column 201-c4 of the example first data record 201 may be for the withdrawal amount, but the fourth column 203-c4 of the example second data record 201 may be for the amount charged to a credit card. Accordingly, to compensate for this difference in types of data, the one or more reformatting processes may append a column to each row 201-r1, 201-r2, 201-r3, 201-r4, and may move the amount charged to a credit card to the appended row. In this way, the one or more reformatting processes may be performed based on the columns of the data records not aligning with each other.

The above examples provide only a few examples of the ways in which the reformatting may occur so that each row of the example aggregated data 205 has the same number of columns Additional examples may include a combination of the above examples. For example, reformatting may be performed by both appending one or more columns and by re-ordering one or more columns. This may be performed, for example, if the data records are for the same or similar types of transactions, but the data records include different numbers of columns and/or the data records have columns that are in different orders from each other.

Examples of data pre-processing are also provided based on the data values of the cells depicted by the example aggregated data 205. For example, the first column 205-c1 of the example aggregated data 205 includes cells with data values such as H(a), H(t), H(f), and H(p). This represents a hashed data value. In particular, example data values a, t, f, and p have been processed through a hashing algorithm, and the results of the hashing algorithm has been placed in the first column 205-c1 of the example aggregated data 205. In this way, data pre-processing may include hashing one or more data values of one or more cells.

The hashing may be performed, for example, based on one or more confidentiality procedures associated with the example data records 201, 203. As one particular example, one or more confidentiality procedures may indicate that the first column 201-c1, 203-c1 of the example data records 201, 203 includes confidential data (e.g., an account number, credit card number, social security number) and that disclosure of the confidential data should be prevented or otherwise restricted. Accordingly, to prevent the confidential data from being included in the example aggregated data 205, the confidential data of those columns 201-c1, 203-c1 may be hashed. The hashed versions of the confidential data (e.g., H(a), H(t), H(f), and H(p)) may be included as part of the example aggregated data 205 and, thus, the example aggregated data 205 may not include the confidential data itself (e.g., a, t, f, p). The hashing algorithm used to generate the hashed versions (e.g., H(a), H(t), H(f), and H(p)) may be a one-way function such that hashed versions cannot be reversed to reveal the confidential data itself (e.g., a, t, f, p). In this way, data privacy may be improved. The one or more confidentiality procedures may indicate the hashing algorithm that is to be used on the confidential data. Any information needed to determine the one or more confidentiality procedures may be received from the two data sources 102, 103, and/or input by a user of the computing platform 110. The above example where confidential is hashed provides one example of the ways in which data privacy may be improved. An additional example may include encrypting the confidential data instead of hashing. In this way, the data pre-processing, by hashing or encrypting confidential data, may include one or more processes that prevent confidential data from being disclosed.

The above example of hashing or encrypting confidential data is only one example of how confidential data can be prevented from being disclosed. Additional data protection or anonymization techniques can be used in addition to or alternatively from the hashing or encrypting mentioned above. Tokenization, data masking, pseudonymization, generalization, data swapping, data perturbation are all additional examples of techniques that could be used in addition to or alternatively from hashing or encrypting. As one example, tokenization may include replacing the confidential data with an identifier and storing, separate from the data record, a mapping between the identifier and the confidential data that can be used to recover the confidential data if needed. The models of the data sources may be trained using data that includes the identifier. In this way, the data pre-processing may include one or more of these additional or alternative techniques.

The data pre-processing may include additional processes not explicitly shown by the examples of FIG. 2. For example, the data pre-processing may include one or more validity processes to determine whether data values are within expected ranges or formatted in expected ways. For example, if a cell is supposed to include an account number, the data value of the account number may be analyzed to determine whether it is valid (e.g., that the account number has expected alphanumeric characters, is of an expected length, and the like).

Examples of the randomized data record aggregation process are also provided by the example aggregated data 205. As depicted, the example aggregated data 205 includes the rows 201-r1, 201-r2, 203-r1, 203-r2 from the example first data record 201 and the example second data record 203. The order in which the rows have been included as part of the example aggregated data 205, however, has been randomized In this way, the randomized process has resulted in the second row 203-r2 of the example second data record 203 being placed between the first row 201-r1 and the second row 201-r1 of the example first data record 201. The randomized process further resulted in the first row 203-r1 of the example first data record 201 being placed after the second row 201-r1 of the example first data record 201. This ordering is only one example of the randomization that may occur as the result of the randomized data record aggregation process. For example, the rows could be ordered differently (e.g., row 203-r1, followed by row 201-r2, followed by row 201-r1, and followed by row 203-r2). Alternatively or additionally, the columns of the data records may be randomized, which may result in the columns being ordered in a randomized fashion.

The randomization of the order in which the rows or columns are included as part of the example aggregation data 205 may improve data privacy. For example, by randomizing the order, data received from the two data sources 102, 103 may be mixed together in such a way that it may be more difficult to determine which source sent a particular piece of data. Indeed, by randomizing the order of the rows 201-r1, 201-r2, 203-r1, 203-r2 from the example first data record 201 and the example second data record 203, it may be more difficult to determine which source sent a particular row of data in the example aggregated data 205 as compared to some alternative processes insofar as there is not pre-set location where rows 201-r1, 201-r2, 203-r1, 203-r2 can be found within the example aggregated data 205. Compare the lack of a pre-set location in the randomized process to an alternative process that always appends data received from the second data source 103 directly after the data received from the first data source 102. In such instances using this alternative process, there would be a pre-set location to look for the data received from the two data sources 102, 103 and, thus, it may be easier to determine which source sent a particular row of data.

After determining the aggregated data 111, the computing platform 110 may, based on the aggregated data 111, determine first selected data 113 and second selected data 115. The determination of the first selected data 113 may be based on a first selecting process 110-2 and the determination of the second selected data 115 may be based on a second selecting process 110-3. Each of the first selecting process 110-2 and the second selecting process 110-3 may select a subset of data from the aggregated data 111 that will be used to train a model at one of the two data sources 102, 103. Accordingly, the first selected data 113 may include a first subset of data from the aggregated data 111 and the second selected data 115 may include a second subset of data from the aggregated data 111. For example, the computing platform 110 may first determine which data sources will be sent selected data. The computing platform 110 may determine to send selected data to all or only some of the data sources. For example, as depicted in FIG. 1, both of the two data sources 102, 103 are shown as being sent selected data. In this way, the computing platform 110 may have determined to send selected data to both of the two data sources 102, 103. The computing platform 110 may then determine selected data for each of the two data sources (e.g., the first selected data 113 and the second selected data 115). The first selected data 113 may be determined by performing the first selecting process 110-2 that, for each cell of the aggregated data 111, determines whether to select or not select that cell for inclusion in the first selected data 113. The second selected data 115 may be determined by performing the second selecting process 110-3 that, for each cell of the aggregated data 111, determines whether to select or not select that cell for inclusion in the second selected data 115. Determining whether to select or not select a cell for inclusion may be performed in a randomized fashion. For example, the computing platform 110 may, for each cell of the aggregated data 111, generate a random number using a random number generator. If that random number is greater or equal to a threshold number, the cell is selected. If that random number is less than the threshold number, the cell is not selected.

The above example may illustrate when all data sources are sent selected data. As an alternative example, a third data source (not should) may have sent data records in addition to the two depicted data sources 102, 103. The computing platform 110 may determine to not send selected data to the third data source. This determination may be performed, for example, by a randomized process (e.g., randomly determine to send or not send to each data source); by a data source not having sent greater than a threshold number of data records (e.g., the third data source may have send less than 2 data records); by a periodic schedule (e.g., the third data source may be sent selected data every other time); by a data source's availability via a network (e.g., the second data source may be offline when selected data is to be sent and not sent data records, but portions of the second data source's data records may still be processed by the other data sources based on the portions inclusion in the selected data); or by some other criteria.

FIG. 2 depicts examples of both the first selected data 113 and the second selected data 115. More particularly, FIG. 2 depicts an example 207 of the first selected data 113 and an example 209 of the second selected data 115. The example 207 of the first selected data 113 may be interchangeably referred to as example first selected data 207. The example 209 of the second selected data 115 may be interchangeably referred to as example second selected data 209. The example first selected data 207 provides an example of how the computing platform 110 may perform the first selecting process 110-2. The example second selected data 209 provides an example of how the computing platform 110 may perform the second selecting process 110-3.

As depicted, the example first selected data 207 and the example second selected data 209 are formatted in rows and columns. The example first selected data 207 has four rows 207-r1 to 207-r4 and eight columns 207-c1 to 207-c8. The example second selected data 209 has four rows 209-r1 to 209-r4 and eight columns 209-c1 to 209-c8. The number of rows and columns in each of the example first selected data 207 and the example second selected data 209 may be the same as the number of rows and columns in the example aggregated data 205. The order of the rows and columns in each of the example first selected data 207 and the example second selected data 209 may be the same as the order of the rows and columns in the example aggregated data 205.

As depicted, the example first selected data 207 includes a first subset of data that was selected from the example aggregated data 205 by the first selecting process 110-2. Accordingly, the example first selected data 207 includes the data value, in the same row and column, for any cell of the example aggregated data 205 that was selected by the first selecting process 110-2. For example, because the cell at first row and the first column of the example aggregated data 205 was selected, the example first selected data 207 includes the data value H(a) in the cell at its first column 207-c1 and its first row 207-r1. The example first selected data 207 includes a blank cell for any cell that was not selected by the first selecting process 110-2. For example, because the cell at the first row and the second column of the example aggregated data 205 was not selected, the example first selected data 207 includes a blank cell at its second column 207-c2 and its first row 207-r1. If the example first selected data 207 is compared to the example aggregated data 205, the example first selected data 207 is shown as having more blank cells than the example aggregated data 205. In this way, the first selecting process 110-2 may result in the example first selected data 207 excluding, by way of one or more blank cells, one or more cells of the example aggregated data 205.

As depicted, the example second selected data 208 includes a second subset of data that was selected from the example aggregated data 205 by the second selecting process 110-3. Accordingly, the example second selected data 209 includes the data value, in the same row and column, for any cell of the example aggregated data 205 that was selected by the second selecting process 110-3. For example, because the cell at first row and the third column of the example aggregated data 205 was selected, the example second selected data 209 includes the data value b in the cell at its third column 209-c3 and its first row 209-r1. The example second selected data 209 includes a blank cell, or a cell having no data, for any cell that was not selected by the second selecting process 110-3. For example, because the cell at the first row and the first column of the example aggregated data 205 was not selected, the example second selected data 209 includes a blank cell at its first column 207-c 1 and its first row 207-r1. If the example second selected data 209 is compared to the example aggregated data 205, the example second selected data 209 is shown as having more blank cells than the example aggregated data 205. In this way, the second selecting process 110-3 may result in the example second selected data 209 excluding, by way of one or more blank cells, one or more cells of the example aggregated data 205.

If the example first selected data 207 is compared to the example second selected data 209, the comparison shows that examples 207, 209 include some cells that were selected by both the first selecting process 110-2 and the second selecting process 110-3. In other words, both the example first selected data 207 and the example second selected data 209 include data values in the same cells. For example, the example first selected data 207 and the example second selected data 209 both include the data value d in the cell at the first row and sixth column. Any cell that is included in both the first selected data 207 and the second selected data 209 may be referred to as an overlapping cell. FIG. 2 indicates an overlapping cell by bolding and underlining the overlapping cell's data value. Accordingly, for the example first selected data 207, the data values d, w, H(f), g, j, and s are bolded and underlined to indicate those cells are included in both the example first selected data 207 and the example second selected data 209. In this way, the first selecting process 110-2 and the second selecting process 110-3 may each result in its respective selected data 207, 209 including one or more overlapping cells. The computing platform 110 may determine and store an indication of the overlapping cells (e.g., a number of overlapping cells between the first selected data 113 and the second selected data 115). Determining and/or storing an indication of the overlapping cells may be performed as part of a selecting process or as a separate process.

If the example first selected data 207 is compared to the example second selected data 209, the comparison shows that the examples 207, 209 include some cells that were selected by one, but not both, of the first selecting process 110-2 and the second selecting process 110-3. In other words, the example first selected data 207 includes one or more first cells that is blank in the example second selected data 209. The example second selected data 209 includes one or more second cells that is blank in the example first selected data 209. For example, the example first selected data 207 includes the data value c in the cell at the first row and fifth column, while the example second selected data 209 has a blank cell at the first row and fifth column. As another example, the example second selected data 209 includes the data value H(t) in the cell at the second row and first column, while the example first selected data 207 has a blank cell at the second row and first column. Any cell that is included in one of the first selected data 207 and the second selected data 209, but not the other, may be referred to as a non-overlapping cell. FIG. 2 indicates a non-overlapping cell by italicizing the non-overlapping cell's data value. Accordingly, for the example first selected data 207, the data values H(a), c, u, v, x, z, l, m, H(p), and q are italicized to indicate those cells are included in the example first selected data 207, but are blank in the example second selected data 209. For the example second selected data 209, the data values b, e, H(t), y, I, n, and r are italicized to indicate those cells are included in the example second selected data 209, but are blank in the example first selected data 207. In this way, the first selecting process 110-2 and the second selecting process 110-3 may each result in its respective selected data 207, 209 including one or more non-overlapping cells. The computing platform 110 may determine and store an indication of the non-overlapping cells (e.g., a number of non-overlapping cells between the first selected data 113 and the second selected data 115). Determining and/or storing an indication of the non-overlapping cells may be performed as part of a selecting process or as a separate process.

If the example first selected data 207 is compared to the example second selected data 209, the comparison shows that the examples 207, 209 can be combined together to regenerate the example aggregated data 205. In other words, each cell of the example aggregated data 205 is included by at least one of the example first selected data 207 and the example second selected data 209. In this way, the first selecting process 110-2 and the second selecting process 110-3 may result in selected data 207, 209 that, together, are usable to regenerate the example aggregated data 205 from which they were selected from.

The above discussion regarding the example first selected data 207 and the example second selected data 209 provides a few examples regarding how the selecting processes 110-2 and 110-3 can be performed. Table I provides a summary of those examples as well as additional examples of how the selecting processes 110-2 and 110-3 can be performed. In particular, each row of Table I provides an example selecting process and a description of selected data that may result from the example selecting process. Each example of Table I may be used on its own as a basis for selecting process 110-2, 110-3. Each example of Table I may be combined with one or more other examples of Table I and used as a basis for selecting process 110-2, 110-3. Additionally, the two selecting processes 110-2, 110-3 may be different from each other insofar as each uses a different combination of the examples listed in Table I.

TABLE I

| Example Selecting Process | Description of Resulting Selected Data |
|---|---|
| A selecting process may be performed to | Selected data may include one or more |
| determine selected data that excludes one or | additional blank cells than the aggregated |
| more cells of aggregated data. | data. |
| A selecting process may be performed to | Selected data may include one or more cells |
| determine selected data that includes one or | that are also included in other selected data. |
| more overlapping cells. | |
| A selecting process may be performed to | Selected data may include one or more cells |
| determine selected data that includes one or | that are not included in other selected data. |
| more non-overlapping cells. | |
| A selecting process may be performed to | Selected data may include one or more cells |
| determine selected data based on randomly | selected from the aggregated data based on |
| selecting cells from aggregated data. | a randomized process that uses a random |
| | number generator. |
| A selecting process may be performed to | Selected data may include cells of one or |
| determine selected data based on randomly | more rows and/or one or more columns, in |
| selecting rows and/or columns from | their entirety, from the aggregated data. The |
| aggregated data. | one or more rows and/or one or more |
| | columns may be selected based on a |
| | randomized process that uses a random |
| | number generator. |
| A selecting process may be performed to | Selected data may include cells selected |
| determine selected data based on selecting | from the aggregated data based on a |
| one or more patterns of cells from | polyomino pattern, such as a tetromino, of |
| aggregated data. | cells from the aggregated data. For example, |
| | a pattern may be placed onto the aggregated |
| | data by randomly selecting a location within |
| | the aggregated data and an orientation for |
| | placing the pattern. Once placed, any cells |
| | underlying the placed pattern may be |
| | selected. |
| A selecting process may be performed to | Selected data, when combined with other |
| determine selected data based on selecting | selected data, can be used to regenerate the |
| cells from the aggregated data such that the | entirety of the aggregated data. |
| aggregated data can be regenerated. | |
| A selecting process may be performed to | Selected data may include confidential data |
| determine selected data based on one or | only as non-overlapping cells and/or |
| more confidentiality procedures associated | selected data may include confidential data |
| with a data source. | only if the selected data is being sent to the |
| | data source that is associated with the one or |
| | more confidentiality procedures. The |
| | confidential data may or may not be hashed |
| | or encrypted. |

After determining the first selected data 113, the computing platform 110 may send the first selected data 113 to the first data source 102. After receiving the first selected data 113, the first data source 102 may train the first model 116 using the first selected data 115. Any suitable training technique may be used. After the first model 116 is trained, the first model 116 may be used to determine first prediction data 118. The first prediction data 118 may be one or more predictions of user behavior based on the first selected data 113 being a subset of data selected from data indicative of banking and credit card transactions. Additionally, after the first model 116 is trained, the first data source 102 may determine first configuration information 120 for the first model 116 (e.g., one or more first model weights and/or one or more first biases) and may send the first configuration information 120 to the computing platform 110. Further, by sending the first configuration information 120 to the computing platform 110, the first data source 102 may be able to prevent the computing platform 110 from being aware of the training algorithm used to train the first model 117.

After determining the second selected data 115, the computing platform 110 may send the second selected data 115 to the second data source 103. After receiving the second selected data 115, the second data source 103 may train the second model 117 using the second selected data 115. Any suitable training technique may be used and may be a different training technique than was used to train the first model 116. After the second model 117 is trained, the second model 117 may be used to determine second prediction data 119. The second prediction data 119 may be one or more predictions of user behavior based on the second selected data 115 being selected from data indicative of banking and credit card transactions. Additionally, after the second model 117 is trained, the second data source 103 may determine second configuration information 121 for the second model 117 (e.g., one or more second model weights and/or one or more second biases) and may send the second configuration information 121 to the computing platform 110. Further, by sending the second configuration information 121 to the computing platform 110, the second data source 103 may be able to prevent the computing platform 110 from being aware of the training algorithm used to train the second model 117.

The models 116, 117 of the two data sources 102, 103 may or may not have restricted access. For example, if access is not restricted to the first model 116, any application or user associated with the first data source 102 may access the first model 116, the first configuration information 119, and/or the first prediction data 116. If access is restricted to the first model 117, only a single application executed by the first data source 102 may have access to the first model 116, the first configuration information 120, and/or the first prediction data 116. Further, the single application may prevent the first model 116, the first configuration information 120, and/or the first prediction data 116 from being accessed, or used, by any other application or user associated with the first data source 102. Indeed, the single application may only allow for the first configuration information 120 to be sent to the computing platform 110.

After receiving the first configuration information 120 and the second configuration information 121, the computing platform 110 may perform a configuration information aggregation process 110-4 that, in part, determines aggregated configuration information 123 for the aggregated model 125 (e.g., one or more aggregated model weights and/or one or more aggregated biases). The configuration information 123 may, for example, combine the first configuration information 120 with the second configuration information 121 using various aggregation techniques (e.g., by summing, normalizing, and/or some other process). The configuration information aggregation process 110-4 may be based on any indications of overlapping and non-overlapping cells. The indications of overlapping and non-overlapping cells may be used to increase or decrease the significance of a model parameter (e.g., increase or decrease the significance of a model weight and/or a bias). For example, if the first selected data 113 and the second selected data 115 have greater than a threshold number of overlapping cells, model weights may be reduced so that they have less influence over the configuration of the aggregated model 125. This reduction may result, for example, because the data sources are regionally-redundant systems that perform redundant processing of transactions and causes duplication of the transactions across the two sources. The impact of the duplication can be lessened by reducing the model weights. As another example, if the first selected data 113 and the second selected data 115 have greater than a threshold number of overlapping cells, model weights may be increased so they have more influence over the configuration of the aggregated model 125. This increase may result, for example, because the data records include many repeated transactions between the same accounts (e.g., transactions representing a monthly bill for the same monthly cost). The impact of the repeated transaction can be increased by increasing the model weights. The computing platform 110 may then configure the aggregated model 125 using the aggregated configuration information 123. After the aggregated model 125 is configured, the aggregated model 125 may be usable to determine aggregated prediction data 126. The aggregated prediction data 126 may be one or more predictions of user behavior based on the aggregated data 111 being indicative of banking and credit card transactions.

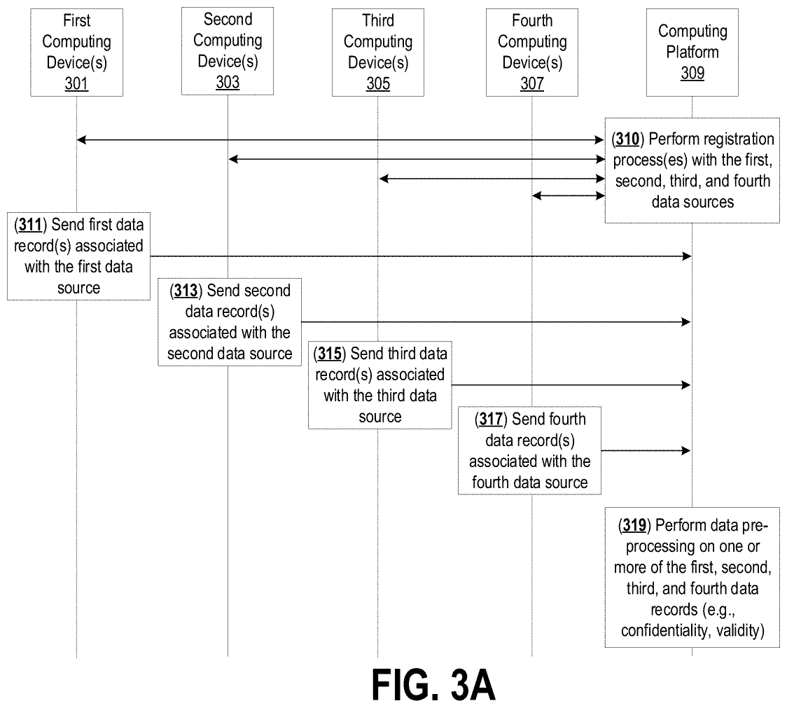

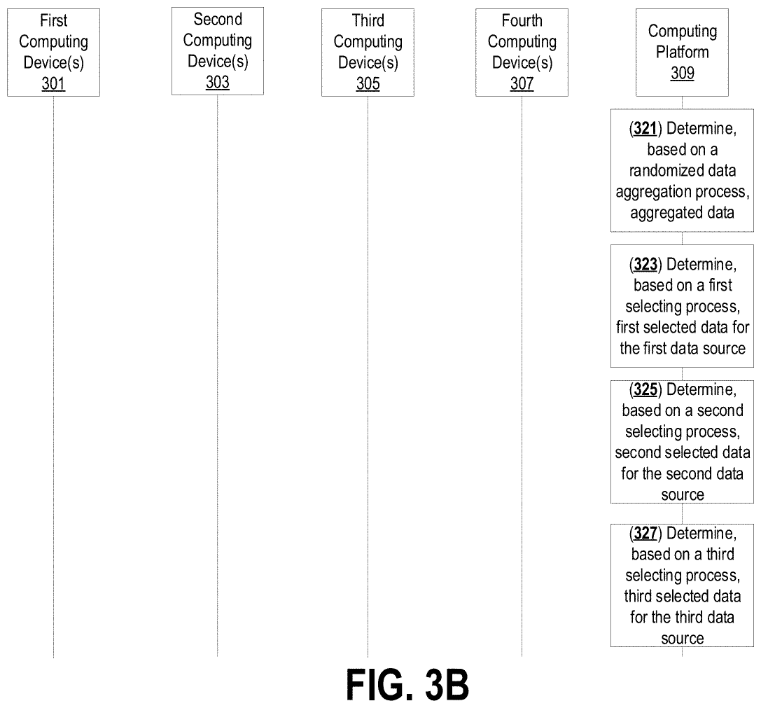

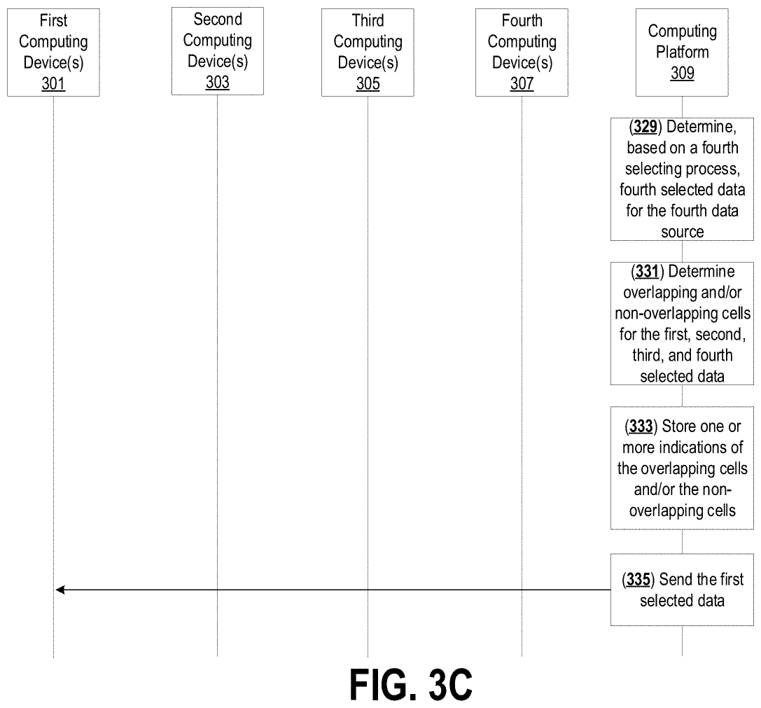

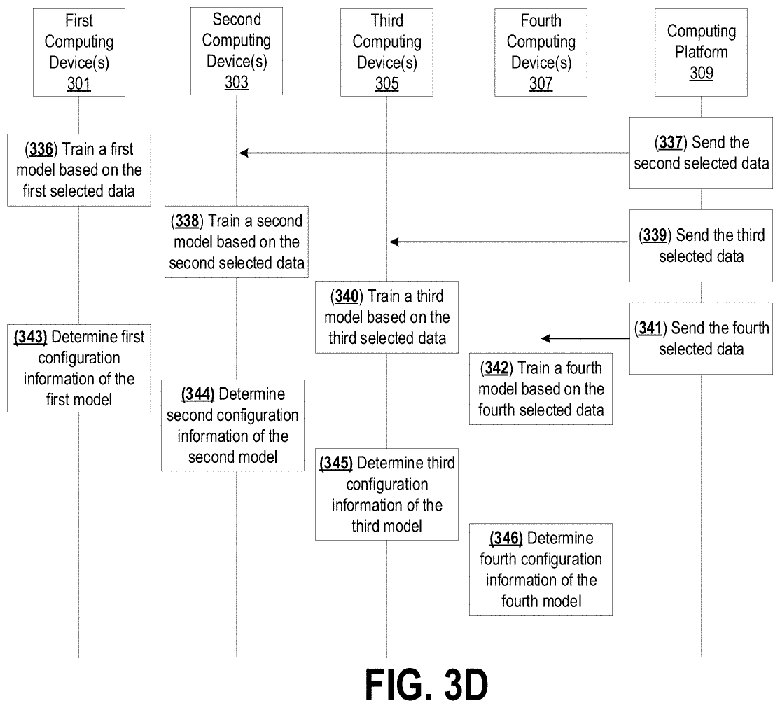

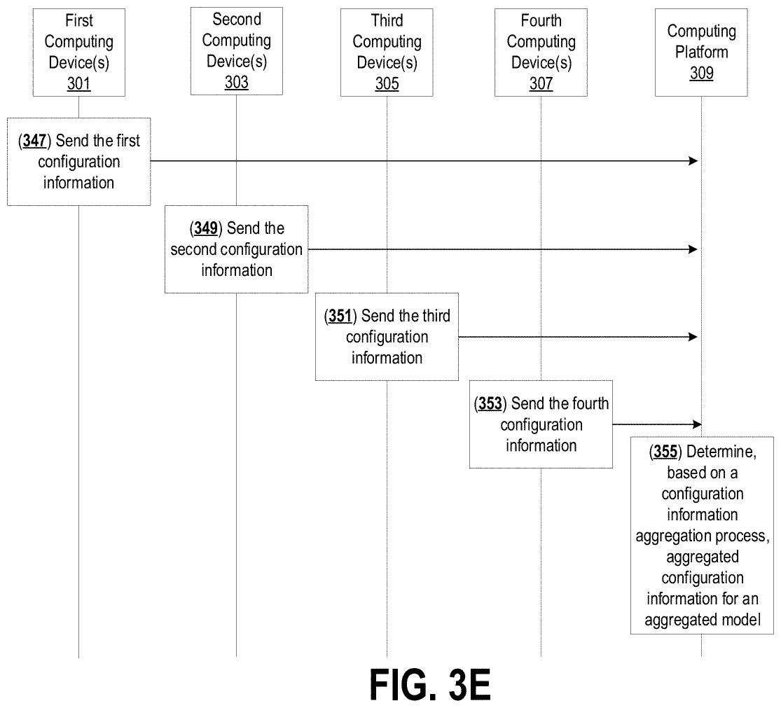

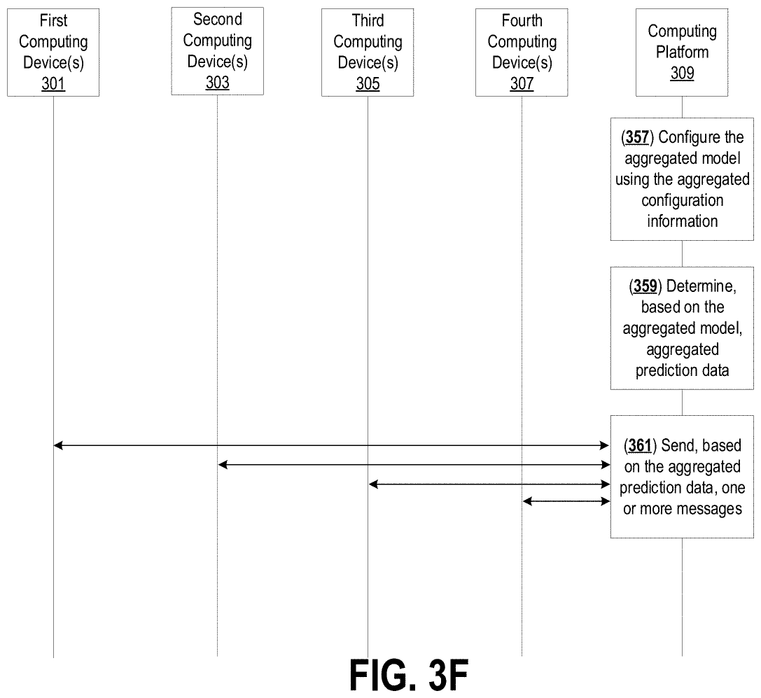

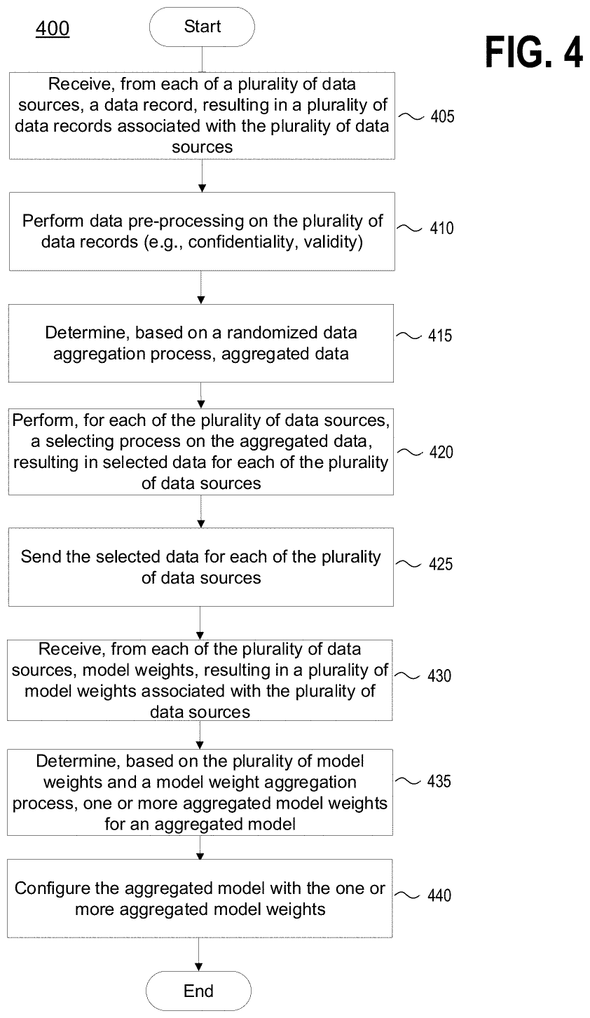

Having discussed the example computing environment 100 of FIG. 1 and the examples of FIG. 2, example flows and methods, which may be performed by various devices of the example computing environment 100, will be discussed. To illustrate the various devices in practice, an example flow will be discussed in connection with FIGS. 3A-3F. FIGS. 3A-3F depict an example flow that includes one or more first computing devices 301, one or more second computing devices 303, one or more third computing devices 305, one or more fourth computing devices 307, and a computing platform 309. Each of the one or more computing devices 301-307 may be associated with its own data source (e.g., the one or more first computing devices 301 may be associated with a first data source, the one or more second computing devices 303 may be associated with a second data source, etc.). The computing platform 209 may be in communication with each of the one or more computing devices 301-307. Mapping the process flow of FIGS. 3A-3F into the example computing environment 100 of FIG. 1, the one or more first computing devices 301 may be one or more devices of the first data source 102, the one or more second computing devices 303 may be one or more devices of the second data source 103, and the computing platform 309 may be the computing platform 110. The one or more third computing devices 305 and the one or more fourth computing devices 307 may be devices of additional data sources not shown in FIG. 1. Additional mappings to the depictions of FIGS. 1, 2A-2D, and 3A-3D will be provided as the example process flow of FIGS. 4A-4D is discussed. In general, the example process flow provides an example of what may occur as the various processes depicted in FIG. 1 are performed. For example, the example process flow depicts what may occur as, among other things, the data pre-processing and randomized data aggregation process 110-1, the first selecting process 110-4, the second selecting process 110-3, and the configuration information aggregation process 110-4 are performed.

The example process flow begins at 310, where computing platform 310 may perform one or more registration processes with the first, second, third, and fourth data sources. A registration process may be performed for each data source that will be in communication with the computing platform 309. A registration process may, among other things, identify a data source as being available for receiving selected data, identify one or more computing devices as being associated with a data source, and may provide information related to the data records that the data source will be sending to the computing platform 309. In this way, the computing platform 309 may be able to, for example, determine whether data records align with each other or not, and may be able to send selected data to any registered data source. As such, a registration process may include one or more communications between the computing platform 309 and any of the one or more first computing devices 301, the one or more second computing devices 303, the one or more third computing devices 305, and the one or more fourth computing devices 307. For example, as part of a registration process for the first data source, the one or more first computing devices 301 may send, to the computing platform 309, a registration request for the first data source. The registration request may include address information for the one or more first computing devices 301, may include an identifier for the first data source, and may include information indicative of the data records the first data source may send to the computing platform 309. The information indicative of the data records may include, for example, an indication of the types of data included by the data records (e.g., a data record includes data indicative of transactions using a first credit card); an indication of the format of the data records (e.g., a number of the rows and/or columns); information indicative of the order in which the data records include the data (e.g., an indication of the order of the columns), an indication of whether the data records include confidential data, an indication of one or more confidentiality procedures associated with the first data source, and the like. Based on the registration request, the computing platform 309 may update a data structure indicative of the registered data sources for later use. Additionally, the computing platform 309 may send data for initializing the model at the first data source. For example, the computing platform 309 may send an untrained model to the one or more first computing devices 301 and this untrained model may be used as the first data source's model (e.g., the first model 115 of FIG. 1). Similar registration processes may be performed for the second, third, and fourth data sources.

After the data sources have been registered, the example flow may continue at 311-317, which depicts the data sources sending data records to the computing platform 309. In particular, at 311, the one or more first computing devices 301 may send, to the computing platform 309, one or more first data records associated with the first data source. At 313, the one or more second computing devices 303 may send, to the computing platform 309, one or more second data records associated with the second data source. At 315, the one or more third computing devices 305 may send, to the computing platform 309, one or more third data records associated with the third data source. At 317, the one or more fourth computing devices 307 may send, to the computing platform 309, one or more fourth data records associated with the fourth data source. Each of the one or more first, second, third, and fourth data records may be the same as, or similar to, the data records discussed in connection with FIGS. 1 and 2 (e.g., data records 105, 107, 201, and 203).

At 319, the computing platform 309 may perform data pre-processing on one or more of the first, second, third, and fourth data records. The data pre-processing may include hashing or encrypting confidential data to prevent the confidential data from being disclosed and/or may include one or more validity processes to determine whether data values of the data records are valid. The data pre-processing may be performed the same as, or similar to, the data pre-processing that was discussed in connection with FIGS. 1 and 2.

The example flow continues at 321 of FIG. 3B, where the computing platform 309 may determine, based on a randomized data aggregation process, aggregated data. The aggregated data may, for example, be determined based on the first, second, third, and fourth data records that were sent at 311-317. The randomized data aggregation process may be performed the same as, or similar to, the randomized data aggregation process that was discussed in connection with FIGS. 1 and 2. The aggregated data may be the same as, or similar to, the aggregated data that was discussed in connection with FIGS. 1 and 2 (e.g., aggregated data 111 and 205).

At 323-329 of FIGS. 3B and 3C, the computing platform 309 may determine selected data for each of the four data sources that registered at 310 of FIG. 3A. Accordingly, at 323, the computing platform 309 may determine, based on a first selecting process, first selected data for the first data source. At 325, the computing platform 309 may determine, based on a second selecting process, second selected data for the second data source. At 327, the computing platform may determine, based on a third selecting process, third selected data for the third data source. At 329, the computing platform 309 may determine, based on a fourth selecting process, fourth selected data for the fourth data source. Each of the four selecting processes may be the same as, or similar to, those discussed in connection with FIGS. 1 and 2 (e.g., the example selecting processes of Table I). Each of the four selected data may be the same as, or similar to, those discussed in connection with FIGS. 1 and 2 (e.g., selected data 113, 115, 207, 209).

At 331 of FIG. 3C, the computing platform 309 may determine overlapping and/or non-overlapping cells for the first, second, third, and fourth selected data. As depicted by the example flow, this determination is performed as a process separate from the four selecting processes. This determination may include, for example, determining a number of overlapping cells for each pair of the four selected data (e.g., the number of overlapping cells in the first selected data and the second selected data, the number of overlapping cells in the second selected data and the fourth selected data, and the like). This determination may include, as another example, determining a number of non-overlapping cells for each pair of the four selected data. (e.g., the number of non-overlapping cells in the first selected data and the second selected data, the number of non-overlapping cells in the first selected data and the third selected data, and the like).

As one example, the computing platform 309 may determine that the first selected data and the second selected data have one or more overlapping cells. The computing platform 309 may also determine that the third selected data and the fourth selected data are without the one or more overlapping cells and/or without any overlapping cells. The computing platform 309 may also determine that the first selected data has one or more first non-overlapping cells, that the second selected data has one or more second non-overlapping cells, that the third selected data has one or more third non-overlapping cells, and that the fourth selected data has one or more fourth non-overlapping cells.

At 333, the computing platform 309 may store one or more indications of the overlapping and/or the non-overlapping cells. These indications may be stored for later use by the computing platform 309. As depicted by the example flow, this storing is performed as a process separate from the four selecting processes.

Continuing the example of 331, the computing platform 309 may store an indication that the first selected data and the second selected data have the one or more overlapping cells. The computing platform 309 may store an indication that the third and fourth selected data are without the one or more overlapping cells and/or without any overlapping cells. The computing platform 309 may store an indication of the one or more first non-overlapping cells, the one or more second non-overlapping cells, the one or more third non-overlapping cells, and the one or more fourth non-overlapping cells.

At 335, 337, 339, and 341 of FIGS. 3C-3D, the computing platform 309 may send the first, second, third, and fourth selected data to the associated data sources. Accordingly, at 335, the computing platform 309 may send the first selected data to the one or more first computing devices 301 of the first data source. At 337, the computing platform 309 may send the second selected data to the one or more second computing devices 303 of the second data source. At 339, the computing platform 309 may send the third selected data to the one or more third computing devices 305 of the third data source. At 341, the computing platform 309 may send the fourth selected data to the one or more fourth computing devices 307 of the fourth data source.

At 336, 338, 340, and 342 of FIG. 3D, the four data sources may train their models based on the received selected data. Accordingly, at 336, the one or more first computing devices 301 may train a first model based on the first selected data. At 338, the one or more second computing devices 303 may train a second model based on the second selected data. At 340, the one or more third computing devices 305 may train a third model based on the third selected data. At 342, the one or more fourth computing devices 307 may train a fourth model based on the fourth selected data. Each data source may train its model the same as, or similar to, the training performed by the data sources 102, 103 of FIG. 1. The models of the four data sources may be the same as, or similar to, the trained models of FIG. 1 (e.g., first model 116 and second model 117).

At 343-346, the four data sources may determine the configuration information of their models. Accordingly, at 343, the one or more first computing devices 301 may determine first configuration information of the first model (e.g., one or more first model weights and/or one or more first biases). At 344, the one or more second computing devices 303 may determine second configuration information of the second model (e.g., one or more second model weights and/or one or more second biases). At 345, the one or more third computing devices 305 may determine third configuration information of the third model (e.g., one or more third model weights and/or one or more third biases). At 347, the one or more fourth computing devices 307 may determine fourth configuration information of the fourth model (e.g., one or more fourth model weights and/or one or more fourth biases). Each of the determined configuration information may be the same as, or similar to, the configuration information 120, 121 of FIG. 1.

At 347-353 of FIG. 3E, the four data sources may send the configuration information to the computing platform 309. Accordingly, at 347, the one or more first computing devices may send the first configuration information to the computing platform 309. At 349, the one or more second computing devices may send the second configuration information to the computing platform 309. At 351, the one or more third computing devices may send the third configuration information to the computing platform 309. At 353, the one or more fourth computing devices may send the fourth configuration information to the computing platform 309.

The example flow does not show the four data sources as determine predictions using their models. For example, the example flow does not explicitly show the one or more first computing devices 301 as determining first prediction data using the first model. This may be considered as a way to illustrate that the four data sources have restricted access to their models. In this way, each of the data sources may be prevented from using their models to make predictions.

At 355, the computing platform 355 may determine, based on a configuration information aggregation process, aggregated configuration information for an aggregated model (e.g., one or more aggregated model weights and/or one or more aggregated biases). This determination may be performed based on the first, second, third, and fourth configuration information. For example, the one or more first model weights, the one or more second model weights, the one or more third model weights, and the one or more fourth model weights may be summed together to determine the one or more aggregated model weights. The one or more first biases, the one or more second biases, the one or more third biases, and the one or more fourth biases may processed based on an or operator or an exclusive or operator to determine the one or more aggregated biases. This determination may also be performed based on any indication of overlapping and/or non-overlapping cells, which were stored at 333 of the example flow. The configuration information aggregation process may be the same as, or similar to, the configuration information aggregation process discussed in connection with FIG. 1. The aggregated model may be the same as, or similar to, the aggregated model 125 of FIG. 1.

At 357, the computing platform 309 may configure the aggregated model using the aggregated configuration information. This configuration of the aggregated model may be performed the same as, or similar to, the manner in which the aggregated model 125 of FIG. 1 is configured.

At 359, the computing platform 309 may determine, based on the aggregated model, aggregated prediction data. This determination may be performed the same as, or similar to the manner in which the aggregated model 125 of FIG. 1 is used to determine aggregated prediction data 126.

At 361, the computing platform 309 may send, based on the aggregated prediction data, one or more messages. These messages may, for example, provide indications of the aggregated prediction data to various entities. These entities may be any of the four data sources or some other computing device that is not associated with any of the four data sources. As such, the example flow illustrates each of the four data sources being sent the one or more messages.

In view of the example flow of FIGS. 3A-4F, the computing platform 309 may configure an aggregated model based on data received from four data sources.

FIG. 4 depicts an example method 400 that may be performed by one or more computing devices that are configured to operate the same as, or similar to, the computing platform 309. As computing platform 309 may be mapped to the computing platform 110 of FIG. 1, additional mappings to the depictions of FIGS. 1, 2, and 3A-3F will be provided as the example method 400 of FIG. 4 is discussed. In this way, method 400 may be performed by any computing device configured to operate the same as, or similar to, the computing platform 110 of FIG. 1. Additionally, the method 400 begins after data sources have been registered with the one or more computing devices. Moreover, the method 400 provides an example where the configuration information includes only model weights. Method 400 may be implemented in suitable computer-executable instructions.

At step 405, the one or more computing devices may receive, from each of a plurality of data sources, a data record, resulting in a plurality of data records associated with the plurality of data sources. Each data record may be the same as, or similar to, the data records discussed in connection with FIGS. 1, 2, and 3A-3F (e.g., data records 105, 107, 201, 203, and those sent at 311-317 of FIG. 3A).

At step 410, the one or more computing devices may perform data pre-processing on the plurality of data records. The data pre-processing may be the same as, or similar to, the data pre-processing discussed in connection with FIGS. 1, 2, and 3A-3F (e.g., hashing confidential data, performing one or more validity processes, etc.).

At step 415, the one or more computing devices may determine, based on a randomized data aggregation process, aggregated data. The randomized data aggregation process may be the same as, or similar to, the randomized aggregation process discussed in connection with FIGS. 1, 2, and 3A-3F. The aggregated data may be the same as, or similar to, the aggregated data discussed in connection with FIGS. 1, 2, and 3A-3F (e.g., aggregated data 111, 205).

At step 420, the one or more computing devices may perform, for each of the plurality of data sources, a selecting process on the aggregated data. Performance of these selecting processes may result in selected data for each of the plurality of data sources (e.g., first selected data for a first data source, second selected data for a second data source, and the like). The selecting processes may be the same as, or similar to, the selecting processes discussed in connection with FIGS. 1, 2, and 3A-3F (e.g., first selecting process 110-2, second selecting process 110-3, the examples of Table I). The resulting selected data may be the same as, or similar to, the selected data discussed in connection with FIGS. 1, 2, and 3A-3F (e.g., first selected data 113, second selected data 115, the selected data determined at 323-329 of FIGS. 3B-3C). Indeed, each selected data may include one or more overlapping cells and/or one or more non-overlapping cells, similar to the example selected data 207, 209 of FIG. 2.

Additionally, as part of one or more of the selecting processes performed at step 420, the one or more computing devices may determine and store indications of overlapping and/or non-overlapping cells. This determination may be performed the same as, or similar to, the determination of overlapping and/or non-overlapping cells discussed in connection with FIGS. 1, 2, and 3A-3F (e.g., determine and store indications as at 331 and 333 of the example flow, except as part of at least one selecting process and not as a separate process as depicted in the example flow).

At step 425, the one or more computing devices may send the selected data for each of the plurality of data sources. In this way, each of the plurality of data sources may be sent its associated selected data. For example, the one or more computing devices may send first selected data to a first data source and may send second selected data to a second data source. This sending may be performed the same as, or similar to, the sending of selected data discussed in connection with FIGS. 1, 2, and 3A-3F.

At step 430, the one or more computing devices may receive, from each of the plurality of data sources, model weights. This receiving may result in the one or more computing devices receiving a plurality of model weights associated with the plurality of data sources. Indeed, the plurality of model weights may include one or more model weights for each of the plurality of data sources (e.g., one or more first model weights for a first data source, one or more second model weights for a second data source, and the like). The receiving and the model weights may be the same as, or similar to, those discussed in connection with FIGS. 1, 2, and 3A-3F (e.g., model weights 120, 121).

At step 435, the one or more computing devices, may determine, based on the plurality of model weights and a model weight aggregation process, one or more aggregated model weights for an aggregated model. The model weight aggregation process and the aggregated model may be the same as, or similar to, the manner in which model weights are aggregated during the configuration information aggregation process discussed in connection with FIGS. 1, 2, and 3A-3F (e.g., configuration information aggregation process 110-4, aggregated model 125).

At step 440, the one or more computing devices may configure the aggregated model using the one or more aggregated model weights. This configuration may be performed the same as, or similar to, the manner in which model weights are used to configure the aggregated models of FIGS. 1 and 3A-3F (e.g., aggregated model 111 and as the aggregated model is configured at 357 of FIG. 3F). Once configured, the aggregated model may be used to determine prediction data (not shown) in manners that are the same as, or similar to, those discussed in connection with FIGS. 1 and 3A-3F.

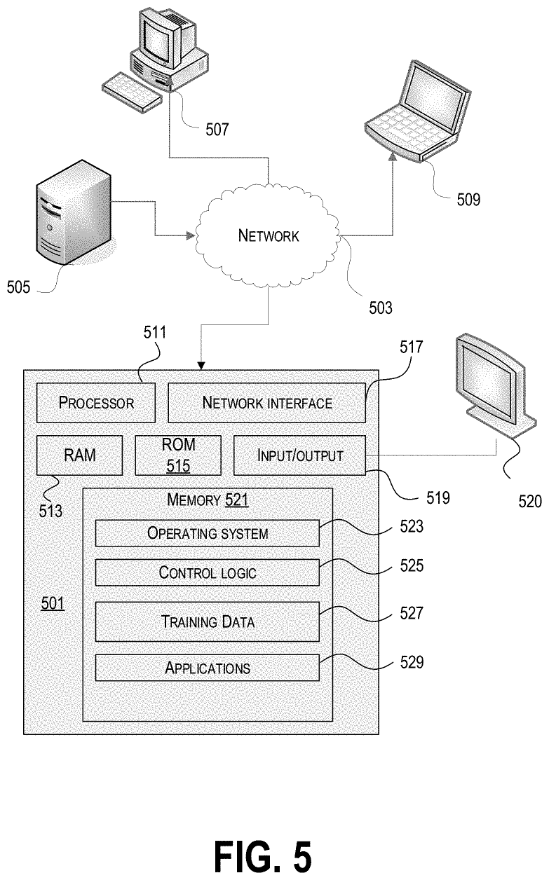

FIG. 5 illustrates one example of a computing device 501 that may be used to implement one or more illustrative aspects discussed herein. For example, the computing device 501 may implement one or more aspects of the disclosure by reading and/or executing instructions and performing one or more actions based on the instructions. The computing device 501 may represent, be incorporated in, and/or include various devices such as a desktop computer, a computer server, a mobile device (e.g., a laptop computer, a tablet computer, a smart phone, any other types of mobile computing devices, and the like), and/or any other type of data processing device.

The computing device 501 may operate in a standalone environment or a networked environment. As shown in FIG. 5, various network nodes 501, 505, 507, and 509 may be interconnected via a network 503, such as the Internet. Other networks may also or alternatively be used, including private intranets, corporate networks, LANs, wireless networks, personal networks (PAN), and the like. Network 503 is for illustration purposes and may be replaced with fewer or additional computer networks. A local area network (LAN) may have one or more of any known LAN topology and may use one or more of a variety of different protocols, such as Ethernet. Devices 501, 505, 507, 509 and other devices (not shown) may be connected to one or more of the networks via twisted pair wires, coaxial cable, fiber optics, radio waves or other communication media.

As seen in FIG. 5, the computing device 501 may include a processor 511, RAM 513, ROM 515, network interface 517, input/output interfaces 519 (e.g., keyboard, mouse, display, printer, etc.), and memory 521. Processor 511 may include one or more computer processing units (CPUs), graphical processing units (GPUs), and/or other processing units such as a processor adapted to perform computations associated with speech processing or other forms of machine learning. I/O 519 may include a variety of interface units and drives for reading, writing, displaying, and/or printing data or files. I/O 519 may be coupled with a display such as display 520. Memory 521 may store software for configuring computing device 501 into a special purpose computing device in order to perform one or more of the various functions discussed herein. Memory 521 may store operating system software 523 for controlling overall operation of the computing device 501, control logic 525 for instructing computing device 501 to perform aspects discussed herein, training data 527, and other applications 529. The training data 527 may include one or more data records (e.g., if the computing device 501 is operating as one of the data sources discussed throughout this disclosure) and/or other data suitable for training a machine learning model. The computing device 501 may include two or more of any and/or all of these components (e.g., two or more processors, two or more memories, etc.) and/or other components and/or subsystems not illustrated here.

Devices 505, 507, 509 may have similar or different architecture as described with respect to computing device 501. Those of skill in the art will appreciate that the functionality of computing device 501 (or device 505, 507, 509) as described herein may be spread across multiple data processing devices, for example, to distribute processing load across multiple computers, to segregate transactions based on geographic location, user access level, quality of service (QoS), etc. For example, devices 501, 505, 507, 509, and others may operate in concert to provide parallel computing features in support of the operation of control logic 525.

One or more aspects discussed herein may be embodied in computer-usable or readable data and/or computer-executable instructions, such as in one or more program modules, executed by one or more computers or other devices as described herein. Generally, program modules include routines, programs, objects, components, data structures, etc. that perform particular tasks or implement particular abstract data types when executed by a processor in a computer or other device. The modules may be written in a source code programming language that is subsequently compiled for execution, or may be written in a scripting language such as (but not limited to) HTML or XML. The computer executable instructions may be stored on a computer readable medium such as a hard disk, optical disk, removable storage media, solid state memory, RAM, etc. As will be appreciated by one of skill in the art, the functionality of the program modules may be combined or distributed as desired in various embodiments. In addition, the functionality may be embodied in whole or in part in firmware or hardware equivalents such as integrated circuits, field programmable gate arrays (FPGA), and the like. Particular data structures may be used to more effectively implement one or more aspects discussed herein, and such data structures are contemplated within the scope of computer executable instructions and computer-usable data described herein. Various aspects discussed herein may be embodied as a method, a computing device, a data processing system, or a computer program product.

Although the subject matter has been described in language specific to structural features and/or methodological acts, it is to be understood that the subject matter defined in any claim is not necessarily limited to the specific features or acts described above. Rather, the specific features and acts described above are disclosed as example forms of implementing any claim or any of the appended claims.

We claim:

1. A method comprising:
determining, based on a first selecting process that selects first cells from aggregated data, first selected data, wherein the aggregated data is formatted into rows and columns, wherein the aggregated data includes data received from a plurality of data sources, and wherein the first selected data includes one or more overlapping cells and one or more first non-overlapping cells;
determining, based on a second selecting process that selects second cells from the aggregated data, second selected data, wherein the second selected data includes the one or more overlapping cells and one or more second non-overlapping cells;
sending, to one or more first computing devices associated with a first data source of the plurality of data sources, the first selected data;
sending, to one or more second computing devices associated with a second data source of the plurality of data sources, the second selected data;
receiving, from the one or more first computing devices, one or more first model weights that are based on training a first model using the first selected data;
receiving, from the one or more second computing devices, one or more second model weights that are based on training a second model using the second selected data;
determining, based on the one or more first model weights and the one or more second model weights, one or more aggregated model weights for an aggregated model; and
configuring the aggregated model using the one or more aggregated model weights.

2. The method of claim 1, wherein the first selecting process is performed based on one or more first data confidentiality procedures associated with the first data source;
wherein the first selecting process results in the one or more first non-overlapping cells including first confidential data associated with the first data source;
wherein the second selecting process is performed based on one or more second data confidentiality procedures associated with the second data source; and
wherein the second selecting process results in the one or more second non-overlapping cells including second confidential data associated with the second data source.

3. The method of claim 1, wherein the first selecting process is performed by selecting the first cells in a randomized fashion.

4. The method of claim 1, wherein determining the one or more aggregated model weights for the aggregated model is performed based on the one or more overlapping cells.

5. The method of claim 1, further comprising:
determining, based on a third selecting process that selects third cells from the aggregated data, third selected data, wherein the third selected data includes a plurality of third non-overlapping cells and is without any overlapping cells;
determining, based on a fourth selecting process that selects fourth cells from the aggregated data, fourth selected data, wherein the fourth selected data includes a plurality of fourth non-overlapping cells and is without any overlapping cells;
sending, to one or more third computing devices associated with a third data source of the plurality of data sources, the third selected data;
sending, to one or more fourth computing devices associated with a fourth data source of the plurality of data sources, the fourth selected data;
receiving, from the one or more third computing devices, one or more third model weights that are based on training a third model using the third selected data;
receiving, from the one or more fourth computing devices, one or more fourth model weights that are based on training a fourth model using the fourth selected data; and
wherein determining the one or more aggregated model weights for the aggregated model is performed based on the one or more third model weights and the one or more fourth model weights.

6. The method of claim 1, further comprising:
receiving, from the one or more first computing devices, one or more first data records;
receiving, from the one or more second computing devices, one or more second data records; and
determining, based on a randomized aggregation process, the aggregated data, wherein the randomized aggregation process aggregates the rows of the one or more first data records and the rows of the one or more second data records into a randomized order.

7. The method of claim 1, further comprising:
receiving, from the one or more first computing devices, one or more first data records that include first confidential data;
receiving, from the one or more second computing devices, one or more second data records that include second confidential data;
hashing the first confidential data, resulting in hashed first confidential data;
hashing the second confidential data, resulting in hashed second confidential data; and
wherein the aggregated data includes the hashed first confidential data and the hashed second confidential data.

8. The method of claim 1, wherein the plurality of data sources includes a third data source; and
wherein the method further comprises determining, based on the plurality of data sources, to send third selected data to the third data source.

9. The method of claim 1, wherein the aggregated data includes one or more first data records associated with the first data source;
wherein the one or more first data record includes data indicative of transactions with users associated with the first data source;
wherein the first model is usable to determine one or more predicted user behaviors for the first data source; and
wherein the aggregated model is usable to determine one or more predicted user behaviors for the plurality of data sources.

10. One or more non-transitory computer-readable media storing executable instructions that, when executed, cause a computing system to:
determine, based on a first selecting process that selects first cells from aggregated data, first selected data, wherein the aggregated data is formatted into rows and columns, wherein the aggregated data includes data received from a plurality of data sources;
determine, based on a second selecting process that selects second cells from the aggregated data, second selected data;
store an indication of whether the first selected data and the second selected data have overlapping cells, wherein the overlapping cells includes any cell that was selected by both the first selecting process and the second selecting process;
send, to one or more first computing devices associated with a first data source of the plurality of data sources, the first selected data;
send, to one or more second computing devices associated with a second data source of the plurality of data sources, the second selected data;
receive, from the one or more first computing devices, one or more first model weights that are based on training a first model using the first selected data;
receive, from the one or more second computing devices, one or more second model weights that are based on training a second model using the second selected data;
based on the one or more first model weights, the one or more second model weights, and the indication of whether the first selected data and the second selected data have overlapping cells, determine one or more aggregated model weights for an aggregated model; and
configure the aggregated model using the one or more aggregated model weights.

11. The one or more non-transitory computer-readable media of claim 10, wherein the first selecting process is performed based on one or more first data confidentiality procedures associated with the first data source; and
wherein the second selecting process is performed based on one or more second data confidentiality procedures associated with the second data source.

12. The one or more non-transitory computer-readable media of claim 10, wherein the first selecting process is performed by selecting the first cells in a randomized fashion.

13. The one or more non-transitory computer-readable media of claim 10, wherein the indication of whether the first selected data and the second selected data have overlapping cells indicates that the first selected data and the second selected data have one or more overlapping cells, and wherein the executable instructions, when executed, cause the one or more apparatuses to determine the one or more aggregated model weights for the aggregated model based on the one or more overlapping cells.

14. The one or more non-transitory computer-readable media of claim 10, wherein the executable instructions, when executed, cause the computing system to:
determine, based on a third selecting process that selects third cells from the aggregated data, third selected data;
determine, based on a fourth selecting process that selects fourth cells from the aggregated data, fourth selected data;
store an indication that the third selected data and the fourth selected data are without any overlapping cells;
send, to one or more third computing devices associated with a third data source of the plurality of data sources, the third selected data;
send, to one or more fourth computing devices associated with a fourth data source of the plurality of data sources, the fourth selected data;
receive, from the one or more third computing devices, one or more third model weights that are based on training a third model using the third selected data;
receive, from the one or more fourth computing devices, one or more fourth model weights that are based on training a fourth model using the fourth selected data; and
wherein the executable instructions, when executed, cause the computing system to determine the one or more aggregated model weights for the aggregated model based on the one or more third model weights, the one or more fourth model weights, and the indication that the third selected data and the fourth selected data are without any overlapping cells.

15. The one or more non-transitory computer-readable media of claim 10, wherein the executable instructions, when executed, cause the computing system to:
receive, from the one or more first computing devices, one or more first data records;
receive, from the one or more second computing devices, one or more second data records; and
determine, based on a randomized aggregation process, the aggregated data, wherein the randomized aggregation process aggregates the rows of the one or more first data records and the rows of the one or more second data records into a randomized order.

16. The one or more non-transitory computer-readable media of claim 10, wherein the executable instructions, when executed, cause the computing system to:
receive, from the one or more first computing devices, one or more first data records that include first confidential data;
receive, from the one or more second computing devices, one or more second data records that include second confidential data;
hash the first confidential data, resulting in hashed first confidential data;
hash the second confidential data, resulting in hashed second confidential data; and
wherein the aggregated data includes the hashed first confidential data and the hashed second confidential data.

17. An apparatus comprising:
one or more processors; and
memory storing executable instructions that, when executed by the one or more processors, cause the apparatus to:
determine, based on a first selecting process that selects first cells from aggregated data, first selected data, wherein the aggregated data is formatted into a number of rows and a number of columns, wherein the aggregated data includes data received from a plurality of data sources, wherein the first selected data includes one or more overlapping cells and one or more first non-overlapping cells, and wherein the first selected data is formatted into the number of rows and the number of columns and includes data values from the aggregated data only at the first cells that were selected by the first selecting process;
determine, based on a second selecting process that selects second cells from the aggregated data, second selected data, wherein the second selected data includes the one or more overlapping cells and one or more second non-overlapping cells, and wherein the second selected data is organized into the number of rows and the number of columns and includes data values from the aggregated data only at the second cells that were selected by the second selecting process;
send, to one or more first computing devices associated with a first data source of the plurality of data sources, the first selected data;
send, to one or more second computing devices associated with a second data source of the plurality of data sources, the second selected data;
receive, from the one or more first computing devices, one or more first model weights that are based on training a first model using the first selected data;
receive, from the one or more second computing devices, one or more second model weights that are based on training a second model using the second selected data;
determine, based on the one or more first model weights and the one or more second model weights, one or more aggregated model weights for an aggregated model; and
configure the aggregated model using the one or more aggregated model weights.

18. The apparatus of claim 17, wherein the first selecting process is performed based on one or more first data confidentiality procedures associated with the first data source;
wherein the first selecting process results in the one or more first non-overlapping cells including first confidential data associated with the first data source,
wherein the second selecting process is performed based on one or more second data confidentiality procedures associated with the second data source; and
wherein the second selecting process results in the one or more second non-overlapping cells including second confidential data associated with the second data source.

19. The apparatus of claim 17, wherein the first selecting process is performed by selecting the first cells in a randomized fashion.

20. The apparatus of claim 17, wherein the executable instructions, when executed by the one or more processors, cause the apparatus to determine the one or more aggregated model weights for the aggregated model based on the one or more overlapping cells.
